(19) United States
(12) Patent Application Publication
(10) Pub. No.: US 2015/0292855 A1
(43) Pub. Date: Oct. 15, 2015

(54) ADJUSTABLE TEMPLATE FOR MEASURING COVERING MATERIALS

(71) Applicant: Rocco RAO, Montreal (CA)

(72) Inventor: Rocco RAO, Montreal (CA)

(21) Appl. No.: 14/687,349

(22) Filed: Apr. 15, 2015

(30) Foreign Application Priority Data
Apr. 15, 2014 (CA) 2849153

(51) Int. Cl. G01B 5/20

(52) U.S. Cl. CPC G01B 5/20

(57) ABSTRACT

An adjustable template device for measuring materials used for laying flooring and covering vertical surfaces, comprising a plurality of slideably interconnected rigid planar contouring members. Each contouring member comprises at least one contouring edge which traces the shape of a contour. Each contouring member further comprises at least one slot which runs centrally along a substantial length of the member, for receiving a fastener which interconnects adjacent members. In a first embodiment, each contouring member has a shape which resembles that of an elongated rectangle. In a second embodiment, at least one of the contouring members has shape that resembles an arc.

### FIELD OF THE INVENTION

The present invention relates to templates and in particular to a template for use in construction for the measuring of materials used for laying flooring and covering vertical surfaces.

### BACKGROUND

In the course of a construction project, construction workers and handymen often have to lay tiles or cover vertical surfaces which are irregular in shape. The process requires a worker to measure the contours of a surface and transfer the measurements onto a tile, or other like material, in order to cut the material to a desired shape. This process is quite time consuming, and requires multiple measurements involving a variety of tools and measurement techniques.

The process is further complicated when the contours of the surface being covered are not defined by simplistic geometric shapes. For example, if the contours of the surface are irregularly curved or angled, the number of measurements required increases drastically. This can result in a particular section of a project taking up a disproportionately high amount of time, which is disadvantageous both for the worker and the client. Further, as each measurement is prone to slight error, the increased number of measurements introduces unnecessary error to the process, potentially affecting the quality of the overall work.

The use of adjustable templates for drawing geometrical shapes on a surface is already well known in the art. Inventions such as U.S. Pat. No. 4,831,739 filed by James A. Davidson on Oct. 11, 1988 and U.S. Pat. No. 2,720,706 filed by Mauno W. Laine on May 14, 1952 describe templates which can be used to draw or cut triangular, rectangular or other polygonal shapes on a surface. These inventions, however, are not ideal for transferring real world measurements onto a surface. Rather, these devices are designed to be adjusted on flat surfaces and in order to measure two dimensional objects therefrom. They are not ideal for measuring the shape and contours of objects in the three dimensional world. Further, the devices are designed to replicate objects that are defined by simplistic geometric shapes, such as rectangles or polygons. They are not adapted to replicate curved or irregular shapes. Further, these inventions are designed to only define closed two-dimensional shapes, whereas the contours in a tiling project can be open or one-dimensional shapes.

The use of templates for defining curved shapes is also well known in the art. For example, the invention U.S. Pat. No. 6,216,354 filed by Martin R. Carbone on Sep. 1, 1998, and the design US D136395 filed by Joseph E. Deckman on Jul. 2, 1943 teach devices for drawing curved lines on a surface. These inventions, however, are not adjustable; they only enable the drawing of predefined curves with a fixed radius, and a regular contour. They are not designed to allow the user to alter the radius of the curve to match his needs, nor to allow the user to easily construct complicated curves with multiple inflexions. Further they are not adapted for taking real-world measurements and transferring them onto another surface.

There is therefore a need for an improved adjustable template which is adapted for measuring real-world irregular straight and curved contours, and transferring the measurements directly to another surface.

### SUMMARY

It is therefore a general object of the present invention to provide an improved template tool which facilitates the measurement of irregular contours and the transfer of said measurements onto a covering material.

The device of the present invention is designed to be assembled along a desired contour. The assembled device serves as a template which is designed for placement over a covering material, allowing the transfer of the contour measurements onto the covering material. Generally, this device comprises a plurality of slideably interconnected rigid contouring members, together forming the shape of a contour. The contouring members are planar, such that they lay flat on a surface. Each of the contouring members comprises at least one contouring edge which is adapted to follow the lines and curves of a contour. Each of these contouring members also comprises at least one slot which runs centrally along a substantial length of the member, for receiving a fastener which interconnects adjacent members. Preferably, the contouring members have calibrated lines for measurement which run over a substantial length along the contouring edge. Preferably, the rigid contouring members are composed of either metal or hard plastic.

In various embodiments of the present invention, the rigid contouring members composing the device may take on a variety of shapes to facilitate the assembly along any type of contour. In one possible embodiment, the device is composed of four rigid contouring members, each of which has a shape which substantially resembles that of an elongated rectangle. In another possible embodiment, the device is composed of four rigid contouring members, two of which have a shape which substantially resembles that of an elongated rectangle, and two of which have a shape which substantially resembles that of an arc. Other embodiments are also possible involving different combinations of member types, and a different number of members.

An advantage of the present invention is that it allows the tracing of a contour using a single measurement. The device is assembled directly up against the contour and can then be used as a template to trace the contour directly onto another surface.

Another advantage of the present invention is that it can replicate any possible contour. Although the individual members have fixed shapes, multiple members can be assembled to represent any desired shape. Several circular members with a fixed radius, for example, can be connected such that they form a circle with a larger radius.

Some objects, advantages and other features will become more apparent upon reading the following non-restrictive description of certain optional configurations, given for the purpose of exemplification only, with reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a top view of the template device, in accordance with a first embodiment of the present invention.

FIG. 2 is a front view of an individual contouring member.

FIG. 3 is a side view of an individual contouring member.

FIG. 4 is a top view of the template device, in accordance with a second embodiment of the present invention.

### DETAILED DESCRIPTION

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

Furthermore, although the present invention may be used for measuring tiling or coverings for horizontal and vertical surfaces, for example, it is understood that it may be used for other construction or drafting work as well.

In addition, although the optional configurations as illustrated in the accompanying drawings comprise various components and although the optional configurations of the template device as shown may consist of certain geometrical configurations as explained and illustrated herein, not all of these components and geometries are essential and thus should not be taken in their restrictive sense, i.e. should not be taken as to limit the scope of the present disclosure. It is to be understood that other suitable components and cooperations thereinbetween, as well as other suitable geometrical configurations may be used for the template device, and corresponding parts, as briefly explained and as can be easily inferred herefrom, without departing from the scope of the disclosure.

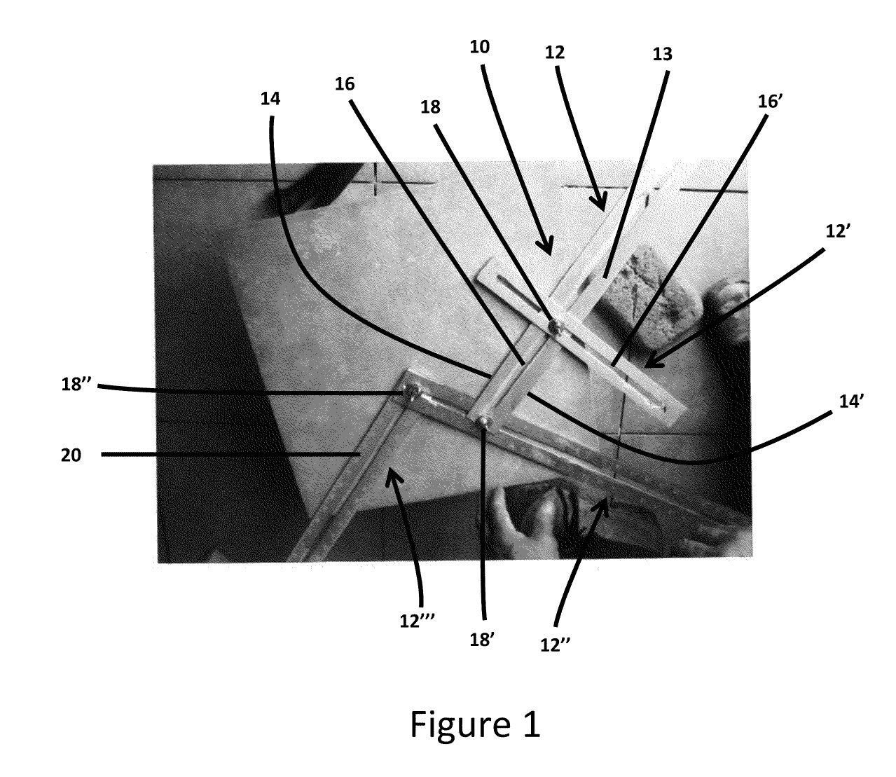

Referring to FIG. 1, according to a first embodiment of the present invention, there is shown a template device 10 adapted for placement over covering material for use in tracing on material a shape which matches that of a desired straight-edged contour. The device 10 comprises a plurality of interconnected rigid planar contouring members 12. In the present embodiment, there are four rigid planar contouring members 12, 12′, 12″, and 12″′ which all substantially resemble the shape of an elongated rectangle. Each of the contouring members 12 comprises a body 13 and two contouring edges 14 and 14′ which run along the length of the body. Each contouring member also has an inner slot 16 which runs centrally along a substantial length of the body 13 of the contouring member, for receiving a fastener 18 which interconnects adjacent members. The fastener 18 interlocks adjacent members such that they are slideably connected along their inner slots 16. The fastener 18 can further be tightened such that the slideable joints become rigid joints, locking adjacent members in their current position and orientation. The body 13 of the contouring members may further be provided with calibrated measuring lines 20 which run along the length of both contouring edges 14 and 14′.

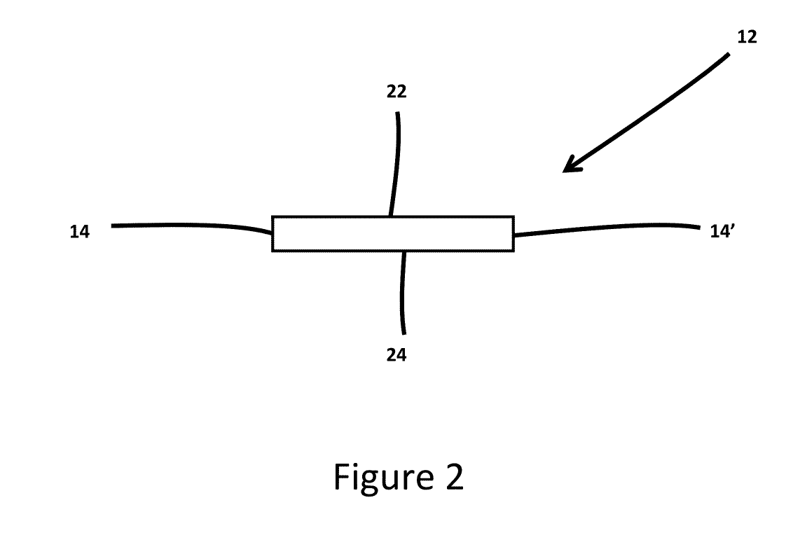

Referring now to FIG. 2, there is shown a front view of an individual contouring member 12 according to a possible embodiment of the invention. The contouring member 12 is provided with a top face 22 and a bottom face 24. In the present embodiment, both the top face 22 and the bottom face 24 have a flat font-profile, such that they are parallel to each other, and parallel to a surface onto which the device is superposed. As such, the contouring member 12 can remain stationary on a flat surface. Other front-profile shapes are of course also possible; the faces can be, for example, curved or provided with ridges, as long as the bottom face 24 can rest stationary on a flat surface. The contouring member 12 is further provided with contouring edges 14 and 14′, which are disposed substantially perpendicular to the top face 22 and the bottom face 24. The contouring edges 14 also have a flat front-profile, such that they can rest naturally up against an object to be measured. Other front-profile shapes for the contouring edges are also possible in different embodiments of the same device.

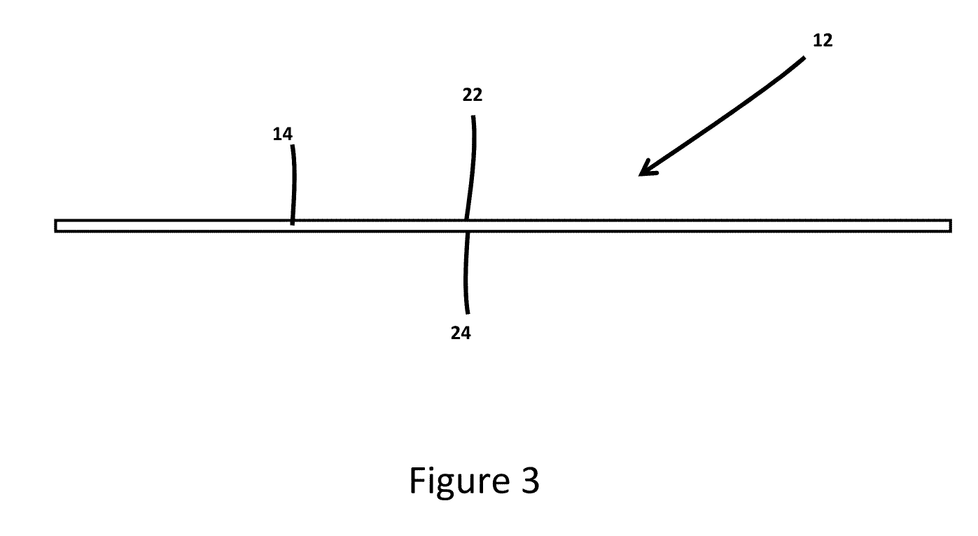

Referring now to FIG. 3, there is shown a side view of an individual contouring member 12. As is best shown in this figure, the contouring edge 14, which is disposed between the top face 22 and the bottom face 24, has a straight side profile. As such, the contouring member 12 is substantially planar, allowing it to rest parallel atop a flat surface, without rocking or moving.

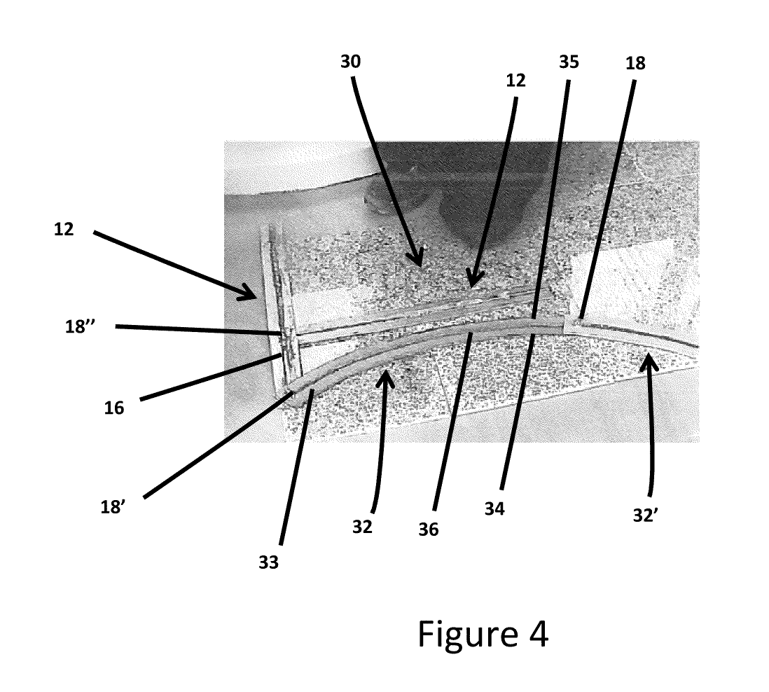

Referring now to FIG. 4, according to a second embodiment of the device, there is shown a template device 30 adapted for placement over covering material for use in tracing on a material a shape which matches that of a desired straight-edged and curve-edged contour. The device 30 comprises a plurality of interconnected rigid planar contouring members 12 and 32. In the present embodiment, there are four rigid planar contouring members, two of which are rectangular-shaped contouring members 12 and 12′, as were described in the embodiment of FIGS. 1, 2 and 3, and two of which are arc-shaped contouring members 32 and 32′. Each of the arc-shaped contouring members 32 comprises a body 33, a concave contouring edge 34 which runs along the inner length of the body 33, and a convex contouring edge 35 which runs along the outer length of the body. Each of the arc-shaped contouring members 32 is provided with an inner slot 36 which runs centrally along the length of the body 33 of the arc-shaped contouring member, for receiving a fastener 18 which interconnect adjacent members. The fastener 18 interlocks adjacent members such that they are slideably connected along their inner slots 36 or 16. The fastener 18 can further be tightened such that the slideable joints become rigid joints, locking adjacent members in their current position and orientation.

### Operation

The device 10 is manipulated to the size and shape of the desired contour by loosening the fastener 18, placing the device 10 up against a contour, and sliding the contouring members 12 such that their contouring edges 14 follow the lines of the contour. The fasteners 18 are then tightened such that the contouring members 12 are rigidly connected, and the overall device 10 retains the shape of the measured contour. The template device 10 can then be transferred atop another surface, such that the bottom face 24 of the individual contouring members rests on, or parallel to the surface. The measured contour is then traced onto that surface by following the contouring edges 14 of the individual contouring members 12, using a pencil, knife or other like tool. The calibrated measuring lines 20 aid in adjusting the template to the desired dimensions.

The device 30 is used in a similar manner. The device 30 is manipulated to the size and shape of the desired contour by loosening the fastener 18, placing the device 30 up against a contour, and sliding the contouring members 12 and 32, such that they follow the lines of the contour. The sliding and rotating of two interconnected arc-shaped contouring members 32 and 32′ allows the device to trace any curved pattern, such as a parabola for example. The fasteners 18 are then tightened such that the contouring members 12, 32 are rigidly connected, and the overall device 30 retains the shape of the measured contour. The template device 30 can then be transferred atop another surface, such that the bottom face 24 of the individual contouring members 24 rests on, or parallel to the surface. The measured contour is then traced on that surface by following the contouring edges 14, 34 of the individual contouring members 12, 32 using a pencil, knife or other like tool. The calibrated measuring lines 20 aid in adjusting the template to the desired dimensions.

Of course, the scope of the claims should not be limited by the preferred embodiments set forth in the examples, but should be given the broadest interpretation consistent with the description as a whole. Numerous modifications could be made to the above-described embodiments without departing from the scope of the claims, as apparent to a person skilled in the art. Furthermore, it is apparent that this invention can apply to many other uses.

1. An adjustable template device adapted for taking measurements of contours and transferring said measurements to a surface, the adjustable template device comprising:
a plurality of slideably interconnected planar contouring members, each contouring member comprising an elongated body having at least one contouring edge and at least one central slot running along a substantial length of said body; and
at least one fastener for slideably interconnecting said contouring members.

2. The adjustable template device according to claim 1, wherein at least one of said contouring members is substantially elongated rectangle shaped.

3. The adjustable template device according to claim 1, wherein at least one of said contouring members is substantially arc-shaped.

4. The adjustable template device according to claim 2, wherein at least one of said contouring members is substantially arc-shaped.

5. The adjustable template device according to claim 1, wherein at least one of said contouring members is provided with calibrated lines for measurement which run along a substantial length of said at least one contouring edge.

6. The adjustable template device according to claim 2, wherein at least one of said contouring members is provided with calibrated lines for measurement which run along a substantial length of said at least one contouring edge.

7. The adjustable template device according to claim 3, wherein at least one of said contouring members is provided with calibrated lines for measurement which run along a substantial length of said at least one contouring edge.

8. The adjustable template device according to claim 4, wherein at least one of said contouring members is provided with calibrated lines for measurement which run along a substantial length of said at least one contouring edge.

9. The adjustable template device according to claim 1, wherein said at least one fastener is engageable such as to lock said adjacent interconnected contouring members in a rigid configuration.

10. The adjustable template device according to claim 2, wherein said at least one fastener is engageable such as to lock said adjacent interconnected contouring members in a rigid configuration.

11. The adjustable template device according to claim 3, wherein said at least one fastener is engageable such as to lock said adjacent interconnected contouring members in a rigid configuration.

12. The adjustable template device according to claim 4, wherein said at least one fastener is engageable such as to lock said adjacent interconnected contouring members in a rigid configuration.

13. The adjustable template device according to claim 5, wherein said at least one fastener is engageable such as to lock said adjacent interconnected contouring members in a rigid configuration.

14. The adjustable template device according to claim 6, wherein said at least one fastener is engageable such as to lock said adjacent interconnected contouring members in a rigid configuration.

15. The adjustable template device according to claim 7, wherein said at least one fastener is engageable such as to lock said adjacent interconnected contouring members in a rigid configuration.

16. The adjustable template device according to claim 8, wherein said at least one fastener is engageable such as to lock said adjacent interconnected contouring members in a rigid configuration.
